(19) United States
(12) Patent Application Publication
(10) Pub. No.: US 2023/0062626 A1
(43) Pub. Date: Mar. 2, 2023

(54) BIOMETRIC AUTHENTICATION DEVICE, BIOMETRIC AUTHENTICATION SYSTEM, BIOMETRIC AUTHENTICATION METHOD, AND NON-TRANSITORY RECORDING MEDIUM STORING BIOMETRIC AUTHENTICATION PROGRAM

(71) Applicant: TOYOTA JIDOSHA KABUSHIKI KAISHA, Aichi-ken (JP)

(72) Inventors: Tomohiro INADA, Kariya-shi (JP); Hitoshi MURAKI, Aichi-ken (JP)

(21) Appl. No.: 17/883,603

(22) Filed: Aug. 9, 2022

(30) Foreign Application Priority Data
Aug. 31, 2021 (JP) 2021-141709

(51) Int. Cl. G06F 21/32; G06F 1/16

(52) U.S. Cl. CPC G06F 21/32; G06F 1/163

(57) ABSTRACT

A biometric authentication device includes an acquirer configured to acquire biometric information related to an eyeball of an occupant of a vehicle from a wearable device worn on the eyeball of the occupant, and an authenticator configured to authenticate the occupant by using the acquired biometric information and prestored biometric information.

### CROSS-REFERENCE TO RELATED APPLICATION

This application claims priority to Japanese Patent Application No. 2021-141709 filed on Aug. 31, 2021, incorporated herein by reference in its entirety.

### BACKGROUND

### 1. Technical Field

The present disclosure relates to a biometric authentication device, a biometric authentication system, a biometric authentication method, and a non-transitory recording medium storing a biometric authentication program.

### 2. Description of Related Art

Japanese Unexamined Patent Application Publication No. 2020-100965 (JP 2020-100965 A) discloses a system in which doors of a vehicle are unlocked by performing facial authentication using a user's facial image captured by a camera mounted on the vehicle.

### SUMMARY

In an access management device of JP 2020-100965 A, the on-board camera images an area around the door in response to detection of a touch operation on the door (doorknob). At this time, the face of a user who touches the doorknob to get into the vehicle is imaged and facial authentication is performed by an image recognizer.

The access management device requires the on-board camera. Depending on the performance of the camera, there is a possibility that the authentication cannot be performed accurately. Therefore, the user's convenience on the access management device may decrease.

The present disclosure provides a biometric authentication device, a biometric authentication system, a biometric authentication method, and a non-transitory recording medium storing a biometric authentication program in which authentication can be performed accurately as compared with the authentication using the on-board camera.

A biometric authentication device according to one aspect of the present disclosure includes an acquirer configured to acquire biometric information related to an eyeball of an occupant of a vehicle from a wearable device worn on the eyeball of the occupant, and an authenticator configured to authenticate the occupant by using the acquired biometric information and prestored biometric information.

In the biometric authentication device, when the acquirer acquires the biometric information from the wearable device worn on the eyeball of the occupant, the occupant is authenticated by using the acquired biometric information and the prestored biometric information. According to the biometric authentication device, the authentication can be performed accurately as compared with the authentication using the on-board camera.

In the biometric authentication device according to the present disclosure, the biometric information may be information related to an iris of the occupant.

In this case, the biometric authentication device can authenticate the occupant accurately.

The biometric authentication device according to the present disclosure may further include a controller configured to control the vehicle based on an authentication result by the authenticator.

In this case, the biometric authentication device can further improve the convenience of the vehicle.

In the biometric authentication device according to the present disclosure, the controller may be configured to perform control to unlock the vehicle based on the authentication result.

In this case, the biometric authentication device can further improve the convenience of the vehicle.

A biometric authentication system according to another aspect of the present disclosure includes the biometric authentication device described above, and a wearable device configure to be worn on the eyeball of the occupant and configured to detect the biometric information of the occupant. The wearable device is configured to detect the biometric information by imaging the eyeball of the occupant.

According to the biometric authentication system, the authentication can be performed accurately as compared with the authentication using the on-board camera.

A biometric authentication method according to another aspect of the present disclosure includes acquiring biometric information related to an eyeball of an occupant of a vehicle from a wearable device worn on the eyeball of the occupant, and authenticating the occupant by using the acquired biometric information and prestored biometric information.

In the biometric authentication method, when the biometric information is acquired from the wearable device worn on the eyeball of the occupant, the occupant is authenticated by using the acquired biometric information and the prestored biometric information. According to the biometric authentication method, the authentication can be performed accurately as compared with the authentication using the on-board camera.

In a non-transitory recording medium storing a biometric authentication program according to another aspect of the present disclosure, the biometric authentication program causes a computer to perform a process including acquiring biometric information related to an eyeball of an occupant of a vehicle from a wearable device worn on the eyeball of the occupant, and authenticating the occupant by using the acquired biometric information and prestored biometric information.

When the biometric information is acquired from the wearable device worn on the eyeball of the occupant, the computer that executes the biometric authentication program stored in the non-transitory recording medium authenticates the occupant by using the acquired biometric information and the prestored biometric information. According to the biometric authentication program, the authentication can be performed accurately as compared with the authentication using the on-board camera.

According to the present disclosure, the authentication can be performed accurately as compared with the authentication using the on-board camera.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a biometric authentication system according to an embodiment;

FIG. 2 is a block diagram showing a hardware configuration of a vehicle according to the embodiment; FIG. 3 is a diagram showing a schematic configuration of a wearable device according to the embodiment;

FIG. 4 is a block diagram showing a functional configuration of an on-board unit according to the embodiment;

FIG. 5 is a flowchart showing a flow of a process to be executed in the biometric authentication system according to the embodiment; and

FIG. 6 is a schematic diagram showing the wearable device that is used for describing display of position information according to the embodiment.

### DETAILED DESCRIPTION OF EMBODIMENTS

A biometric authentication system including a biometric authentication device according to one aspect of the present disclosure will be described. The biometric authentication device acquires information from a wearable device worn by a user who is an occupant of a vehicle, and controls the vehicle based on the information.

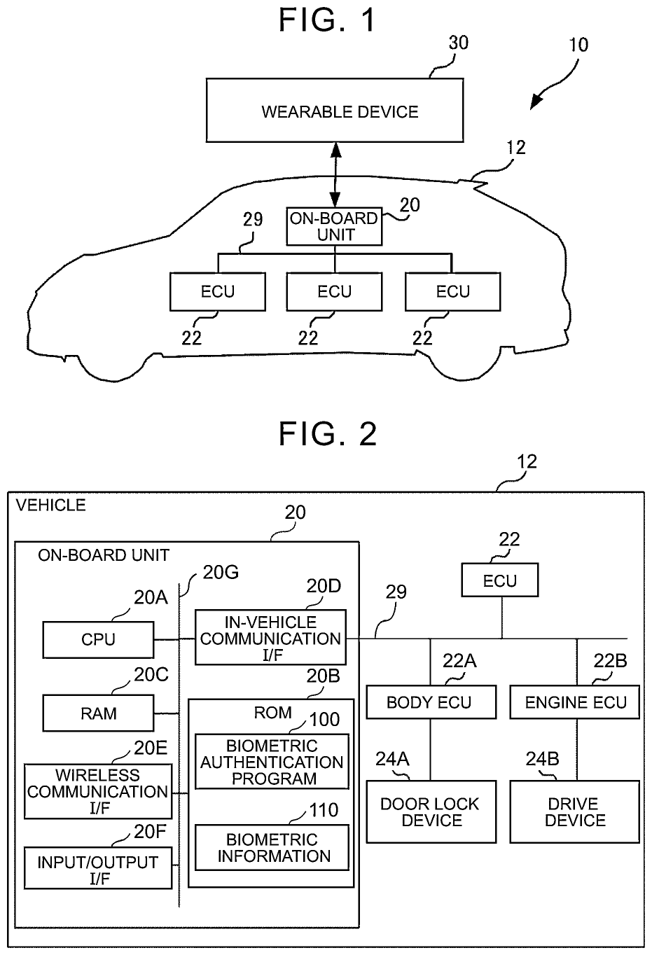

As shown in FIG. 1, a biometric authentication system 10 of the present embodiment includes a vehicle 12 including an on-board unit 20 as an example of the biometric authentication device, and a wearable device 30. The vehicle 12 includes the on-board unit 20 and a plurality of electronic control units (ECUs) 22 serving as control devices. The on-board unit 20 and the wearable device 30 are connected to each other by wireless communication such as Bluetooth (registered trademark).

The on-board unit 20 has a function of acquiring communication information transmitted from each ECU 22 based on a controller area network (CAN) protocol, and a function of transmitting communication information to control each ECU.

The wearable device 30 is a contact lens type wearable device that is worn on an eyeball of the user of the vehicle. The wearable device 30 has a function of acquiring biometric information such as an iris of the user from the eyeball of the user and transmitting the biometric information to the on-board unit 20.

As shown in FIG. 2, the on-board unit 20 includes a central processing unit (CPU) 20A, a read only memory (ROM) 20B, a random access memory (RAM) 20C, an in-vehicle communication interface (I/F) 20D, a wireless communication I/F 20E, and an input/output I/F 20F. The CPU 20A, the ROM 20B, the RAM 20C, the in-vehicle communication I/F 20D, the wireless communication I/F 20E, and the input/output I/F 20F are communicably connected to each other via an internal bus 20G.

The CPU 20A is a central processing unit that executes various programs and controls various units. That is, the CPU 20A reads the program from the ROM 20B, and executes the program by using the RAM 20C as a work area.

The ROM 20B stores various programs and various kinds of data. The ROM 20B of the present embodiment stores a biometric authentication program 100 that acquires biometric information from the wearable device 30 to perform authentication, and biometric information 110 including information related to an iris of a preregistered user. The RAM 20C temporarily stores the program or data as the work area.

The in-vehicle communication I/F 20D is an interface for connection to the ECUs 22. This interface performs communication based on the controller area network (CAN) protocol. In the in-vehicle communication I/F 20D, a communication standard based on Ethernet (registered trademark) may be applied. The in-vehicle communication I/F 20D is connected to an external bus 29. That is, data transmitted or received between the on-board unit 20 and each ECU 22 is transmitted or received on the external bus 29 as a communication frame based on the CAN protocol.

The wireless communication I/F 20E is a wireless communication module for communicating with the wearable device 30. For example, a communication standard based on Bluetooth (registered trademark) is used for the wireless communication module. The communication standard is not limited to this standard. Communication standards such as the fifth-generation standard (5G), long term evolution (LTE), and Wi-Fi (registered trademark) may be used for the wireless communication module.

The input/output I/F 20F is an interface for communicating with a microphone, a loudspeaker, a monitor, a camera, and the like (not shown).

The ECUs 22 includes a body ECU 22A and an engine ECU 22B, and respective on-board devices 24 are connected to the ECUs 22.

The body ECU 22A is connected to a door lock device 24A and performs control to unlock doors of the vehicle 12 based on an authentication result for biometric information.

The engine ECU 22B is connected to a drive device 24B and controls an engine based on the authentication result for biometric information.

The door lock device 24A is an electronic lock that controls locking and unlocking of the doors of the vehicle 12. The drive device 24B drives the engine of the vehicle 12.

As shown in FIG. 3, the contact lens type wearable device 30 includes a control unit 30A, a display unit 30B, a storage unit 30C, a camera unit 30D, a sensor unit 30E, and a communication unit 30F. The control unit 30A, the display unit 30B, the storage unit 30C, the camera unit 30D, the sensor unit 30E, and the communication unit 30F are connected to each other by a circuit (not shown). In the circuit (not shown), wiring is formed by using ink having conductivity.

The control unit 30A is a microcomputer such as a microchip including a CPU, a ROM, and a RAM, and controls each component of the wearable device 30. That is, the CPU reads a program from the ROM, and executes the program by using the RAM as a work area. The ROM stores various programs and various kinds of data. The RAM temporarily stores the program or data as the work area.

The display unit 30B includes multiple display elements (not shown) arranged in a grid pattern. The display element is, for example, an organic electroluminescence (EL) display device, and is arranged in a region overlapping a pupil of an eyeball in the wearable device 30.

The storage unit 30C is a non-volatile memory and stores images and data acquired by each unit constituting the wearable device 30.

The camera unit 30D includes a lens module including an imaging lens, an aperture, and the like, a drive module that performs a zoom operation on the lens module, and an imaging element that acquires imaging light obtained by the lens system as an imaging signal. The imaging lens according to the present embodiment is oriented inward to image an eyeball including an iris of an occupant wearing the wearable device 30.

The sensor unit 30E includes various sensors including a temperature sensor, a tear detection sensor, and a light detection sensor. The temperature sensor detects a temperature on the surface of an eyeball. The tear detection sensor detects an amount of droplets secreted on the surface of an eyeball by measuring an electrical resistance value of tear fluid. The light detection sensor detects light entering an eyeball to detect the blink of an occupant.

The communication unit 30F is a wireless communication module for communicating with the on-board unit 20. For example, a communication standard based on Bluetooth (registered trademark) is used for the wireless communication module. The communication unit 30F performs a process of transmitting and receiving various kinds of data by an antenna (not shown).

The wearable device 30 of the present embodiment sets positions of images and texts to be displayed on the display unit 30B based on an image captured by the camera unit 30D. As a result, the wearable device 30 can display the images and texts by superimposing the images and texts on a real image that is a display target of the images and texts.

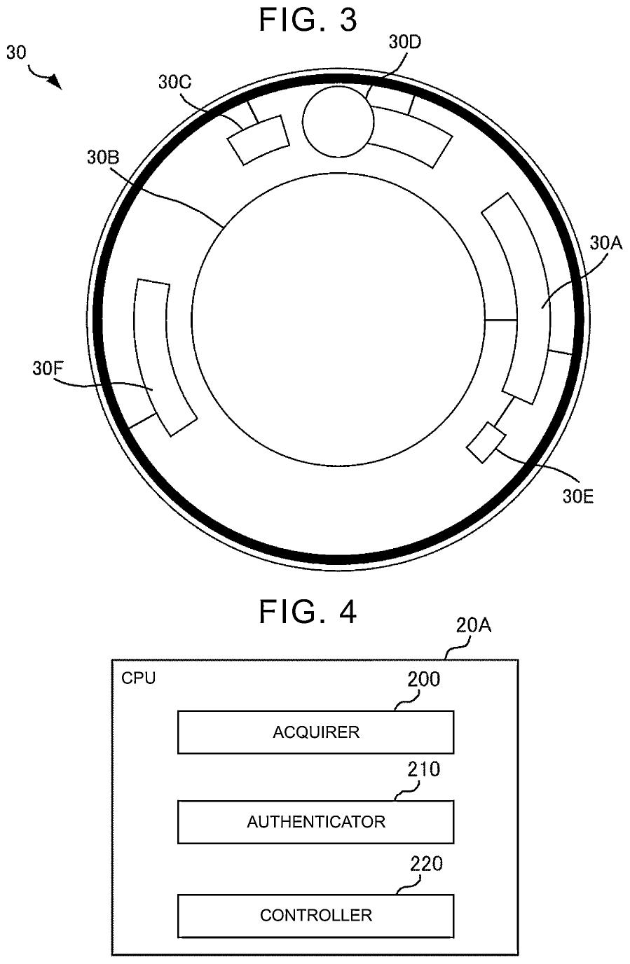

As shown in FIG. 4, the CPU 20A of the on-board unit 20 of the present embodiment functions as an acquirer 200, an authenticator 210, and a controller 220 by executing the biometric authentication program 100.

The acquirer 200 acquires biometric information of an occupant from the wearable device 30. Examples of the biometric information include an image of an eyeball including an iris of a user.

The authenticator 210 authenticates the user by using the acquired biometric information and biometric information prestored in the ROM 20B and including information related to the iris of the user.

Specifically, an image of the iris of the user is prestored as the prestored biometric information, and the authenticator 210 performs verification by comparing the image of the iris related to the acquired biometric information and the image of the iris related to the stored biometric information. When the verification result shows that the image of the iris related to the acquired biometric information corresponds to the image of the iris related to the stored biometric information, the authenticator 210 authenticates the user as a preregistered user.

When the user is authenticated by the authenticator 210 as a result of the authentication, the controller 220 controls the vehicle 12.

Specifically, the controller 220 controls the body ECU 22A to unlock the doors of the vehicle 12 as the control related to the vehicle 12.

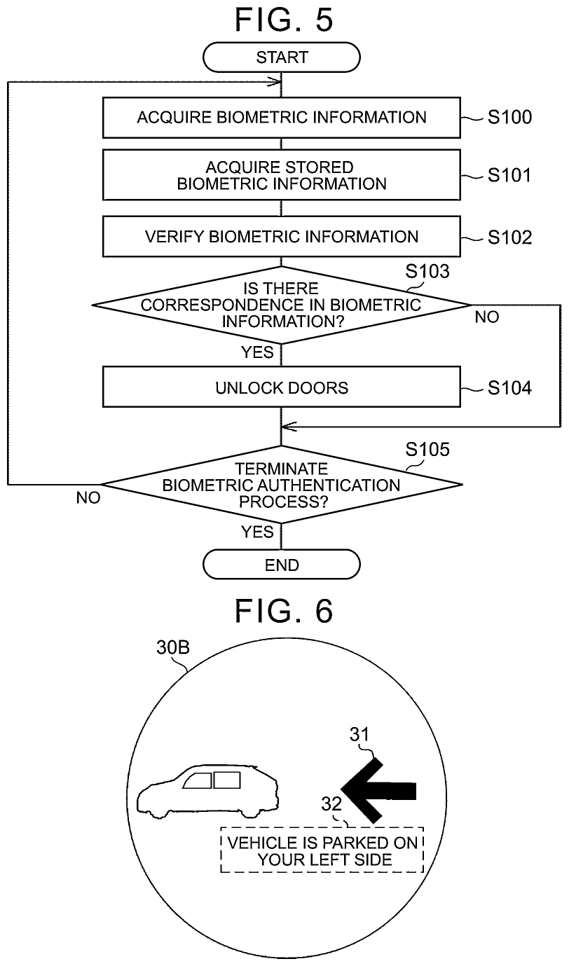

A flow of a process to be executed in the biometric authentication system 10 according to the present embodiment will be described with reference to a flowchart of FIG. 5. A process in the on-board unit 20 is implemented by the CPU 20A functioning as the acquirer 200, the authenticator 210, and the controller 220. The process shown in FIG. 5 is executed, for example, when a user inputs an instruction to execute the biometric authentication program or when the on-board unit 20 and the wearable device 30 are connected by pairing or the like.

In Step S100, the CPU 20A acquires biometric information from the wearable device 30.

In Step S101, the CPU 20A acquires biometric information stored in the ROM 20B. In the present embodiment, description has been given about the case where preregistered biometric information is stored in the ROM 20B. The present disclosure is not limited to this case. The preregistered biometric information may be stored in an external storage device. For example, the CPU 20A may acquire the biometric information stored in the external storage device via a network.

In Step S102, the CPU 20A verifies the acquired biometric information against the stored biometric information.

In Step S103, the CPU 20A determines whether the verification result shows that the acquired biometric information corresponds to the stored biometric information. When the acquired biometric information corresponds to the stored biometric information (Step S103: YES), the CPU 20A proceeds to Step S104. When the acquired biometric information does not correspond to the stored biometric information (Step S103: NO), the CPU 20A proceeds to Step S105.

In Step S104, the CPU 20A controls the body ECU 22A to unlock the doors.

In Step 5105, the CPU 20A determines whether to terminate the process for authenticating the biometric information. When determination is made to terminate the process for authenticating the biometric information (Step S105: YES), the CPU 20A terminates the process. When determination is made not to terminate the process for authenticating the biometric information (Step S105: NO), the CPU 20A proceeds to Step S100 to acquire biometric information.

In the on-board unit 20 of the present embodiment, when the acquirer 200 acquires the biometric information from the wearable device 30 worn on the eyeball of the user, the user is authenticated by using the acquired biometric information and the prestored biometric information.

According to the present embodiment described above, the authentication can be performed accurately as compared with authentication using an on-board camera.

Description has been given about the case where the biometric information according to the embodiment described above is the image including the iris of the eyeball. The present disclosure is not limited to this case. The biometric information may be blood vessels in the eyeball.

For example, the on-board unit 20 may prestore information related to the blood vessels in the eyeball of the user, and perform authentication by verifying biometric information acquired by the wearable device 30 and indicating an image of the blood vessels in the eyeball of the user against the prestored biometric information related to the blood vessels in the eyeball.

Description has been given about the case where the controller 220 according to the embodiment described above unlocks the doors. The present disclosure is not limited to this case. The controller 220 may control the engine ECU 22B to start the engine, or may notify the user about the position of the vehicle 12.

For example, the controller 220 may perform control to start the engine when the user is authenticated by the authenticator 210 as a result of the authentication.

The controller 220 may perform control to turn ON headlights to inform the occupant about the position of the vehicle 12 when the user is authenticated by the authenticator 210 as a result of the authentication.

When the user is authenticated, the acquirer 200 further acquires position information of the vehicle 12 and position information of the user, and the controller 220 transmits, to the wearable device 30, information indicating a positional relationship between the vehicle 12 and the occupant. The wearable device 30 may show the position of the vehicle 12 to the occupant by displaying the received information indicating the positional relationship on the display unit 30B.

For example, as shown in FIG. 6, the wearable device 30 causes the display unit 30B to display a direction 31 indicating a stopped position of the vehicle 12 and a message 32 indicating the position of the vehicle 12 based on the received information indicating the positional relationship by superimposing the direction 31 and the message 32 on a scene viewed by the occupant. By displaying the direction 31 indicating the stopped position of the vehicle 12 and the message 32 indicating the position of the vehicle 12 on the display unit 30B, the correspondence between the information shown by the wearable device 30 and the scene viewed by the occupant can easily be grasped and convenience is improved.

Description has been given about the case where the wearable device 30 according to the embodiment described above transmits data to and receives data from the on-board unit 20 by using Bluetooth (registered trademark). The present disclosure is not limited to this case. For example, the wearable device 30 may transmit data to and receive data from the on-board unit 20 via Wi-Fi (registered trademark). For example, the on-board unit 20 functions as a connection point of Wi-Fi (registered trademark) to achieve connection to the wearable device 30 at a longer distance as compared with Bluetooth (registered trademark). When the on-board unit 20 is connected to the wearable device 30 by Wi-Fi (registered trademark), the on-board unit 20 may acquire the biometric information from the wearable device 30, authenticate the occupant, and notify the occupant about the position of the vehicle 12.

The various processes that are executed by the CPU 20A and the CPU of the control unit 30A by reading software (programs) in the embodiment described above may be executed by various processors other than the CPUs. Examples of the processor in this case include a programmable logic device (PLD) whose circuit configuration can be changed after manufacture, such as field-programmable gate array (FPGA), and a dedicated electric circuit that is a processor having a circuit configuration designed exclusively to perform a specific process, such as application-specific integrated circuit (ASIC). The above processes may be performed by one of the various processors, or may be performed by a combination of two or more processors of the same type or different types (for example, a plurality of FPGAs or a combination of a CPU and an FPGA). The hardware structure of the various processors is more specifically an electric circuit in which circuit elements such as semiconductor devices are combined.

In the embodiment described above, description has been given about the case where each program is prestored (preinstalled) in a non-transitory computer-readable recording medium. For example, the biometric authentication program to be used by the CPU 20A is prestored in the ROM 20B. The present disclosure is not limited to this case, and each program may be provided by being recorded on a non-transitory recording medium such as compact disc read-only memory (CD-ROM), digital versatile disc read-only memory (DVD-ROM), and Universal Serial Bus (USB) memory. The program may be downloaded from an external device via a network.

What is claimed is:

1. A biometric authentication device comprising:
an acquirer configured to acquire biometric information related to an eyeball of an occupant of a vehicle from a wearable device worn on the eyeball of the occupant; and
an authenticator configured to authenticate the occupant by using the acquired biometric information and prestored biometric information.

2. The biometric authentication device according to claim 1, wherein the biometric information is information related to an iris of the occupant.

3. The biometric authentication device according to claim 1, further comprising a controller configured to control the vehicle based on an authentication result by the authenticator.

4. The biometric authentication device according to claim 3, wherein the controller is configured to perform control to unlock the vehicle based on the authentication result.

5. A biometric authentication system comprising:
the biometric authentication device according to claim 1; and
a wearable device configured to be worn on the eyeball of the occupant and configured to detect the biometric information of the occupant, wherein the wearable device is configured to detect the biometric information by imaging the eyeball of the occupant.

6. A biometric authentication method comprising:
acquiring biometric information related to an eyeball of an occupant of a vehicle from a wearable device worn on the eyeball of the occupant; and
authenticating the occupant by using the acquired biometric information and prestored biometric information.

7. A non-transitory recording medium storing a biometric authentication program, the biometric authentication program causing a computer to perform a process comprising:
acquiring biometric information related to an eyeball of an occupant of a vehicle from a wearable device worn on the eyeball of the occupant; and
authenticating the occupant by using the acquired biometric information and prestored biometric information.
